(19) United States
(12) Patent Application Publication
(10) Pub. No.: US 2025/0217788 A1
(43) Pub. Date: Jul. 3, 2025

(54) Methods, Systems, and Electronic Devices for Scheduling Electronic Payment Transactions According to Occasion

(71) Applicant: Motorola Mobility LLC, Chicago, IL (US)

(72) Inventors: Krishnan Raghavan, Bangalore (IN); Rahul Sahadevan, Nagpur (IN); Nakul Patel, Ernakulam Cochin (IN)

(21) Appl. No.: 18/402,597

(22) Filed: Jan. 2, 2024

(51) Int. Cl. G06Q 20/28; G06Q 20/10

(52) U.S. Cl. CPC G06Q 20/28; G06Q 20/108

(57) ABSTRACT

A method in an electronic device receives, at a user interface, user input requesting an electronic payment transaction. The method presents, by one or more processors on the user interface in response to the receiving, a user actuation target facilitating the electronic payment transaction by occasion. The method retrieves, with a communication device from a remote electronic device across a network, one or more upcoming occasions. The method also presents, by the one or more processors on the user interface, the one or more upcoming occasions as execution dates for the electronic payment transaction.

### BACKGROUND

### Technical Field

This disclosure relates generally to electronic payment transaction systems, and more particularly to electronic devices configured to schedule electronic payment transactions in an electronic payment transaction system.

### Background Art

Portable electronic devices, such as smartphones and tablet computers, are now the primary electronic tools with which people communicate, engage in commerce, maintain calendars and itineraries, monitor health, capture images and video, and surf the Internet. In many instances, a person is more likely to carry a smartphone than a watch or wallet. Indeed, with the advent of personal finance, banking, and shopping applications many people can transact personal business solely using a smartphone and without the need for cash or a physical credit card.

In many cultures, it is common to give gifts to friends, family, and charities on special occasions. It would be advantageous to have improved electronic devices and corresponding methods and systems that simplify this process.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory method in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates one explanatory system flow diagram in accordance with one or more embodiments of the disclosure.

FIG. 5 illustrates one or more embodiments of the disclosure.

FIG. 6 illustrates a prior art method.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receive user input requesting an electronic payment transaction, retrieving one or more upcoming occasions, and presenting the one or more upcoming occasions as execution dates for the electronic payment transaction. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of presenting, by one or more processors on a user interface of an electronic device in response to an electronic payment transaction request, a plurality of occasions, receiving a selection of one or more occasions to execute an electronic payment transaction identified by the electronic payment transaction request, and executing the electronic financial transaction on the occasion selected, be it annually or one time, as described herein. The non-processor circuits may include, but are not limited to, a radio receiver, a radio transmitter, signal drivers, clock circuits, power source circuits, and user input devices. As such, these functions may be interpreted as steps of a method to perform the causing a schedule by occasion user actuation target to be presented on a user interface and, in response to actuation of the schedule by occasion user actuation target, presenting a plurality of upcoming occasions for execution of the electronic payment transaction on the user interface. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, across cultures it is common to give gifts to friends, family, and charities on special occasions. Embodiments of the disclosure contemplate that many modern electronic devices include financial applications, messaging applications, and shopping applications, and that these applications can indeed be made to give such gifts.

Illustrating by example, Motorola Mobility has launched a banking application called DIMO.sup.TM in Brazil. Digital banking applications such as DIMO.sup.TM are redefining banking. Indeed, DIMO.sup.TM already has more than one hundred thousand users of the system in Brazil as expects for that number to only continue to grow.

This, as well as other, banking applications are redefining the way that banking occurs. Rather than having to go to a bank to physically talk to a teller during business hours to complete a financial transaction, banking applications offer “24-7” banking with instantaneous transfers of money. Banking can be done exclusively using a smartphone. Even automated teller machine (ATM) withdrawals can be made using only a smartphone.

The advent of applications such as DIMO.sup.TM are leading to users simply ceasing to carry paper currency or coins. Moreover, applications like DIMO.sup.TM have caused people to stop carrying physical credit and debit cards as well since the credit and debit card account information can simply be loaded into a smartphone, with near field and other communication devices allowing direct transactions of money electronically.

With the increased adoption of electronic payments, the gifts that people make to family, friends, and charities on these special occasions have begun to occur using applications like DIMO.sup.TM. Embodiments of the disclosure contemplate that the events at which these gifts are made often occur regularly, i.e., every year, every month, and so forth. However, embodiments of the disclosure contemplate that these events do not always happen on the same date. Illustrating by example, Thanksgiving in the United States occurs on the fourth Thursday of November. This could be the 22^{nd}, the 23^{rd}, the 24^{th}, or another date. While some are somewhat predictable like Thanksgiving, falling on a particular Thursday, others are based upon more obscure reference points, examples of which include planetary positions, organizational announcements, or other factors.

Due to this randomness of day upon which a particular occasion may fall, it becomes difficult to impossible for a user to accurately schedule a payment for a particular occasion. While banks may offer the ability to schedule a payment on a particular date, they do not allow a payment to be scheduled on an occasion.

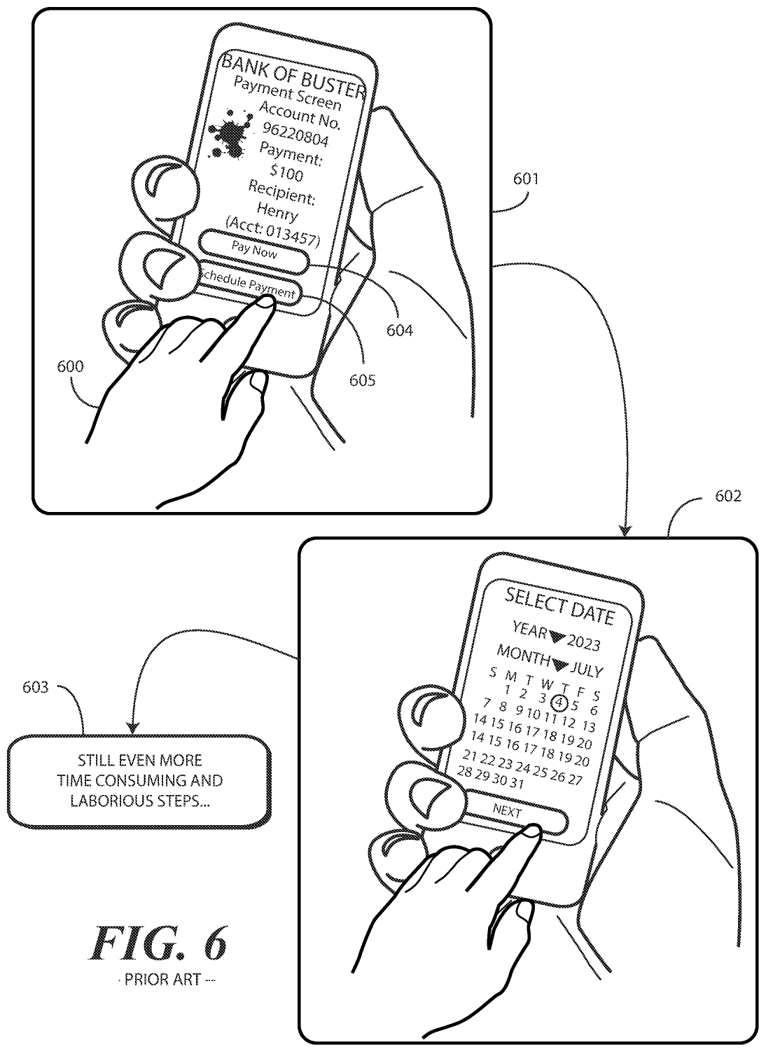

To illustrate this, turn now to FIG. 6. As shown at step 601, a user 600 is attempting to schedule a payment from the Bank of Buster to a friend of the user 600 named Henry. The application interface presents two user actuation targets: a first user actuation target 604 allowing the payment to be completed now, and another user actuation target 605 allowing the payment to be scheduled.

The problem is, as shown at step 602, when this second user actuation target 605 is actuated the user 600 must manually scheduling the payment date by selecting the month, the year, the date, and then even performing more tedious and time-consuming steps at step 603. What's more, if the user 600 does not know the date of the special occasion on which he wants the payment to be made, the user 600 will have to exit the banking application, launch another application such as a web browser to look up the date of the special occasion, remember that date of the special occasion, close the web browser, reenter the banking application, navigate to the date, and so forth. These are just some of the myriads of tedious and time-consuming steps the user may need to perform at step 603.

As can be seen from this example, the manual entry of electronic financial transactions on dates corresponding to specific occasions, when those occasions move from date-to-date year-to-year, is a real drag. A user is required to remember the day corresponding to a particular occasion, navigate several menus, manually select the date, and make the payment. If all of these operations are not executed perfectly, the user runs the risk of missing the payment, making it too early or too late, or even being indecisive and not committing to the cause for which the payment is intended to support.

Consider the following example: Over the past three years, Chad has been transferring money to a charity every Thanksgiving. While most of Chad's regular payments are scheduled ones, this annual gift is not because Thanksgiving fails to fall on a consistent day every year. However, in the spirit of Thanksgiving, Chad wants his gift to be received exactly on the day of thanks.

Now consider that it is 2022 and the period around Thanksgiving gets really busy for Chad. Accordingly, he forgets about scheduling his gift. As he heads back to work after a long, holiday weekend, he receives a polite message from the charity thanking him his contribution over the years and asking why he missed giving this year. After reveling in the holiday weekend, Chad feels terrible having missed his gift. He now has to make the payment late.

Or consider this example: Krish transfers money to his sister every year for the Indian festival of Diwali. This festival generally falls somewhere between late October and early November each year. Given his forgetful ways, Krish simply schedules the payment to occur on October 25 each year. He does this because he's at least reasonably confident that Diwali will not occur before that date.

Unfortunately, in 2017 Diwali occurred a bit too early, commencing on October 19. When Krish's scheduled payment was ultimately executed, the festival was long over. Sadly, when Krish's sister received the money, she cheekily messaged him asking if the gift was intended for the next year since he missed this one. As everyone knows, the real fun of Diwali is receiving a gift on the date the festival starts. Poor Krish, downtrodden, feels horrible for letting his sister down.

Advantageously, embodiments of the disclosure provide a solution to these dilemmas by allowing users to schedule electronic financial transactions on specific events or occasions. In one or more embodiments, systems, methods, and electronic devices present occasions by fetching occasions and events from an official resource and presenting those occasions on a user interface for user selection. One or more processors of an electronic device then register the requestion on a special event or occasion. The one or more processors fetch the exact date for the occasion and get ready for the payment.

In one or more embodiments, the one or more processors can alert the user about any impending payment a predefined number of days before the electronic financial transaction is finalized. The one or more processors can cause the electronic financial transaction to transfer money to a designated recipient in accordance with a schedule, as well as informing the user as to when these payments schedule.

In one or more embodiments, a method in an electronic device comprises receiving, at a user interface, user input requesting an electronic payment transaction. In one or more embodiments, the method comprises one or more processors of the electronic device presenting a user actuation target facilitating the electronic payment transaction by occasion.

In one or more embodiments, the one or more processors retrieve one or more occasions using a communication device from a remote electronic device across a network and then present the one or more upcoming occasions as execution dates for the electronic payment transaction. When the user interface receives a selection of at least one occasion, the one or more processors schedule the electronic payment transaction for execution on the at least one occasion.

In one or more embodiments, an electronic device comprises a user interface, a communication device, and one or more processors operable with the user interface and the communication device. In one or more embodiments, the one or more processors are operable to, in response to user input received by the user interface requesting execution of an electronic payment transaction, cause a schedule by occasion user actuation target to be presented on the user interface and, in response to actuation of the schedule by occasion user actuation target, present a plurality of upcoming occasions available for execution of the electronic payment transaction on the user interface. In one or more embodiments, the one or more processors cause the electronic payment transaction to be executed on an occasion selected from the plurality of upcoming occasions.

In one or more embodiments, a method comprises presenting, by one or more processors on a user interface in response to an electronic payment transaction request, a plurality of occasions, receiving, by the user interface, a selection of one or more occasions to execute an electronic payment transaction identified by the electronic payment transaction request, and determining, by the one or more processors from user input received by the user interface with the selection, whether the electronic payment transaction request is a singular electronic payment transaction request or an annual electronic payment transaction request.

In one or more embodiments, when the electronic payment transaction request is a singular electronic payment transaction request, the one or more processors cause the electronic payment transaction to execute on the one or more occasions. However, when the electronic payment transaction request is an annual electronic payment transaction request, the one or more processors cause the electronic payment transaction request to execute on the one or more occasions every year.

Other features can be included as well. For instance, the one or more processors can present a prompt prior to the electronic payment transaction request occurring. In one or more embodiments, the prompt is presented within a predefined number of days prior to the one or more occasions indicating that the electronic payment transaction request will occur. In one or more embodiments, the one or more processors can also determine a date occasion of the one or more occasions. The one or more processors can cause the electronic payment transaction to execute on that date.

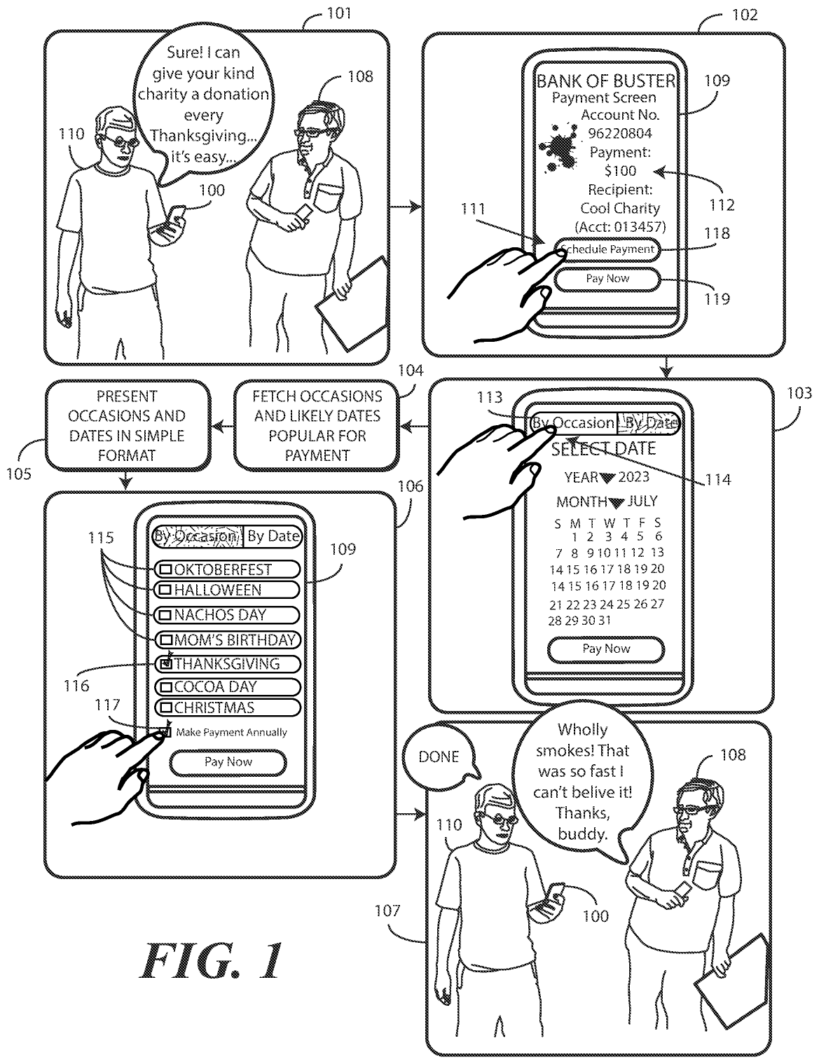

To see how embodiments of the disclosure can operate, turn now to FIG. 1. At step 101, a charity representative 108 is asking a user 110 using an electronic device 100 configured in accordance with one or more embodiments of the disclosure if the user 110 would like to make an annual donation to the charity every Thanksgiving. Armed with an electronic device 100 configured in accordance with one or more embodiments of the disclosure, and believing in the charity, the user 110 readily accepts, noting that despite the holiday falling on different days of the year, scheduling an annual gift will be a snap.

At step 102, in response to the user input received at step 101, the one or more processors present an electronic payment transaction scheduling user actuation target 118 that allows the electronic financial transaction to be scheduled for a future date. In this illustrative embodiment, the electronic payment transaction scheduling user actuation target 118 is presented alongside an electronic payment transaction execution user actuation target 119.

At step 102, the user interface 109 of the electronic device 100, which in this embodiment is a touch-sensitive display, receives user input 111 actuating the electronic payment transaction scheduling user actuation target 118, which requests that an electronic payment transaction 112 be scheduled for a future date. At step 103, one or more processors of the electronic device 100 present a user actuation target 113 facilitating electronic payment by occasion. At step 103, the user interface 109 also receives user input 114 actuating the user actuation target 113 facilitating the electronic payment transaction by occasion.

At step 104, a communication device of the electronic device 100 retrieves, from a remote electronic device across a network, one or more upcoming occasions 115. At step 105, the one or more processors of the electronic device 100 present the one or more upcoming occasions 115 on the user interface 109. The result is shown at step 106, where the upcoming occasions 115 are presented on the user interface 109.

At step 106, the user 110 selects a Thanksgiving user actuation target 116 as the upcoming occasion on which they desire the electronic payment transaction 112 to occur. Moreover, in this illustrative embodiment the one or more processors of the electronic device 100 present, on the user interface 109 a periodic execution user actuation target 117 allowing the electronic payment transaction to become an annual electronic payment transaction request. In one or more embodiments, when the periodic execution user actuation target 117 is actuated, one or more processors of the electronic device 100 schedule the electronic payment transaction 112 to execute on the selected occasion periodically. In this illustrative embodiment, the periodic execution user actuation target 117 is presented beneath the list of upcoming occasions 115.

In this illustrative embodiment, the periodic execution user actuation target 117 comprises an annual execution target because Thanksgiving and Thanksgiving is an annual holiday. Had the holiday been a monthly holiday, semi-annual holiday, quarterly holiday, or other type of holiday, the periodic execution user actuation target 117 could have been a different frequency user actuation target. In any event, the user 110 selects this periodic execution user actuation target 117 in addition to selecting Thanksgiving user actuation target 116, thereby indicating that the user 110 desires the electronic payment transaction 112 to be an annual electronic payment transaction request.

At step 107, the user 110 alerts the charity representative 108 that an annual gift will be made to the charity every year, on Thanksgiving, regardless of what date Thanksgiving falls upon. Having asked hundreds of people to make the same donation, the charity representative 108 is shocked with how fast the user 110 was able to schedule annual gifts on a floating holiday. Since the one or more processors of the electronic device 100 have received a selection of the at least one occasion, in response the one or more processors schedule the electronic payment transaction 112 to execute on the at least one occasion, which is Thanksgiving in this example.

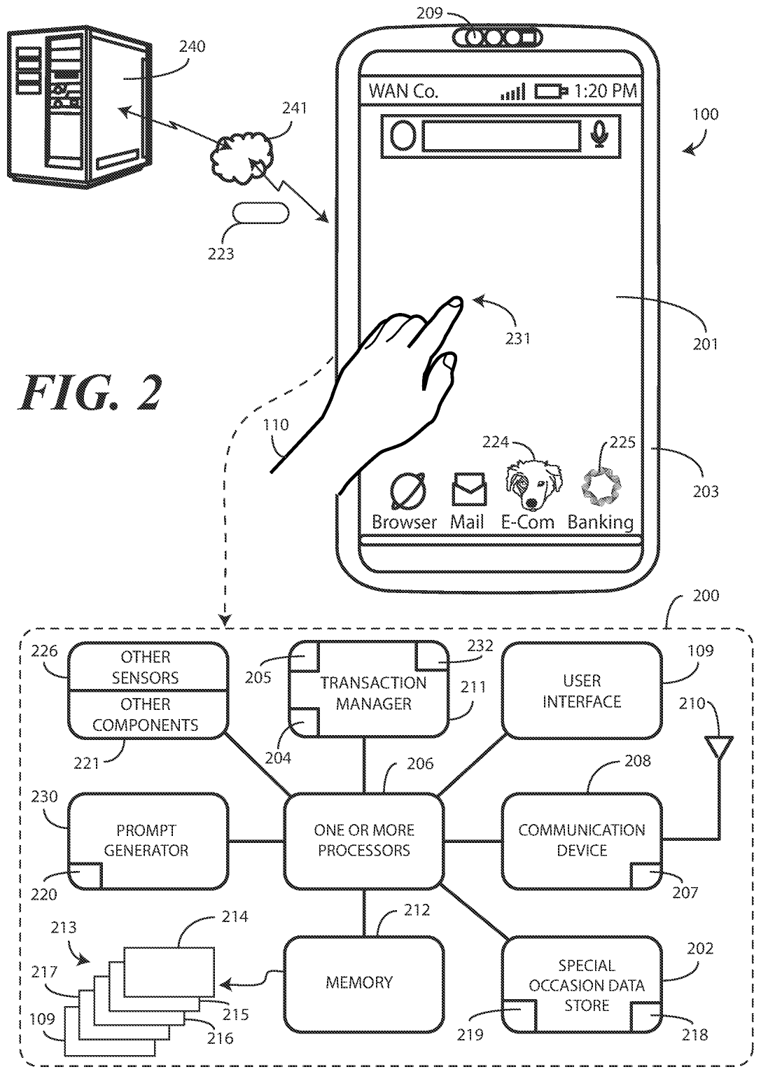

Turning now to FIG. 2, illustrated therein is one electronic device 100 configured in accordance with one or more embodiments of the disclosure. The electronic device 100 of this illustrative embodiment includes a user interface 109. In one or more embodiments, the user interface 109 comprises a display 201, which may optionally be touch-sensitive. The display 201 can serve as a primary user interface 109 of the electronic device 100.

Where the display 201 is touch sensitive, users can deliver user input to the display 201 by delivering touch input from a finger, stylus, or other objects disposed proximately with the display. In one embodiment, the display 201 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 2 includes a housing 203. Features can be incorporated into the housing 203. Examples of features that can be included along the housing 203 include an imager 209, shown as a camera in FIG. 2, or an optional speaker port. A user interface component, which may be a button or touch sensitive surface, can also be disposed along the housing 203.

A block diagram schematic 200 of the electronic device 100 is also shown in FIG. 2. In one embodiment, the electronic device 100 includes one or more processors 206. In one embodiment, the one or more processors 206 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 212, can optionally store the executable software code used by the one or more processors 206 during operation.

In this illustrative embodiment, the electronic device 100 also includes a communication device 208 that can be configured for wired or wireless communication with one or more other devices or networks. The networks can include a wide area network, a local area network, and/or personal area network. The communication device 208 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 208 can include wireless communication circuitry, one of a receiver, a transmitter, or transceiver, and one or more antennas 210.

The electronic device 100 can optionally include a near field communication circuit 207 used to exchange data, power, and electrical signals between the electronic device 100 and another electronic device. In one embodiment, the near field communication circuit 207 is operable with a wireless near field communication transceiver, which is a form of radio-frequency device configured to send and receive radio-frequency data to and from the companion electronic device or other near field communication objects.

Where included, the near field communication circuit 207 can have its own near field communication circuit controller in one or more embodiments to wirelessly communicate with companion electronic devices using various near field communication technologies and protocols. The near field communication circuit 207 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 206 can be responsible for performing the primary functions of the electronic device 100. For example, in one embodiment the one or more processors 206 comprise one or more circuits operable to present presentation information, such as images, text, and video, on the display 201. The executable software code used by the one or more processors 206 can be configured as one or more modules 213 that are operable with the one or more processors 206. Such modules 213 can store instructions, control algorithms, and so forth.

In one embodiment, the one or more processors 206 are responsible for running the operating system environment 214. The operating system environment 214 can include a kernel, one or more drivers, and an application service layer 215, and an application layer 216. The operating system environment 214 can be configured as executable code operating on one or more processors or control circuits of the electronic device 100.

The application service layer 215 can be responsible for executing application service modules. The application service modules may support one or more applications 217 or “apps.” Examples of such applications include a cellular telephone application for making voice telephone calls, a web browsing application configured to allow the user to view webpages on the display 201 of the electronic device 100, an electronic mail application configured to send and receive electronic mail, a photo application configured to organize, manage, and present photographs on the display 201 of the electronic device 100, and a camera application for capturing images with the imager 209. Collectively, these applications constitute an “application suite.” In one or more embodiments, these applications comprise one or more e-commerce applications 224 and/or banking applications 225 that allow electronic commerce orders to be placed and financial transactions to be made using the electronic device 100.

Illustrating by example, in one or more embodiments a user can deliver user input to an e-commerce application 224 or a banking application 225 to enter an electronic payment transaction request 232 or otherwise request an electronic payment transaction occur. In one or more embodiments, when this occurs, the one or more processors cause the communication device 208 to retrieve one or more upcoming occasions 223 from a remote electronic device 240 across a network 241. Examples of remote electronic devices 240 from which these upcoming occasions 223 can be retrieved include government servers, public date presentation servers, religious servers, official organization servers and so forth. Thereafter, the one or more processors 206 the display 201 to present the one or more processors upcoming occasions 223 as described above with reference to step (105) of FIG. 1.

In one or more embodiments, in response to user input 231 received by the user interface 109 requesting execution of an electronic payment transaction (112), the one or more processors 206 cause a schedule by occasion user actuation target to be presented on the user interface 109. When that schedule by occasion user actuation target is actuated, the one or more processors 206 present a plurality of upcoming occasions available for execution of the electronic payment transaction on the user interface 109.

In one or more embodiments, the one or more processors 206 are responsible for managing the applications and all personal information received from the user interface 109 that is to be used by the finance application 224 and/or banking application 225 after the electronic device 100 is authenticated as a secure electronic device and the user identification credentials have triggered an electronic payment transaction request 232. The one or more processors 206 can also be responsible for launching, monitoring, and killing the various applications and the various application service modules. In one or more embodiments, the one or more processors 206 are operable to not only kill the applications, but also to expunge any and all personal data, data, files, settings, or other configuration tools when the electronic device 100 is reported stolen or when the finance application 224 and/or banking application 225 are used with fraudulent activity to wipe the memory 212 clean of any personal data, preferences, or settings of the person previously using the electronic device 100.

The one or more processors 206 can also be operable with other components 221. The other components 221, in one embodiment, include input components, which can include acoustic detectors as one or more microphones. The one or more processors 206 may process information from the other components 221 alone or in combination with other data, such as the information stored in the memory 212 or information received from the user interface.

The other components 221 can include a video input component such as an optical sensor, another audio input component such as a second microphone, and a mechanical input component such as button. The other components 221 can include one or more sensors 226, which may include key selection sensors, touch pad sensors, capacitive sensors, motion sensors, and switches. Similarly, the other components 221 can include video, audio, and/or mechanical outputs.

The one or more sensors 226 may include, but are not limited to, accelerometers, touch sensors, surface/housing capacitive sensors, audio sensors, and video sensors. Touch sensors may be used to indicate whether the electronic device 100 is being touched at side edges. The other components 221 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, the electronic device 100 comprises a special occasion data store 202 that stores occasions retrieved by the communication device 208 from the remote electronic device 240 across the network 241 so that they can be presented on the user interface 109. This allows the one or more processors 206 to retrieve, from the memory 212 of the electronic device 100, the one or more upcoming occasions 223. In some embodiments, the special occasion data store 202 stores these one or more upcoming occasions 223 in a list.

Embodiments of the disclosure also contemplate that while some upcoming occasions will be global upcoming occasions, e.g., Diwali or Thanksgiving, other upcoming occasions will be more personal in nature. Examples of personal upcoming occasions 218 include birthdays, anniversaries, events with friends, and so forth. These personal upcoming occasions 218 can be gleaned from personal calendars, incoming communications such as text messages and email correspondence received by the communication device 208, or from other sources. In one or more embodiments, the special occasion data store 202 stores these personal upcoming occasions 218 so they can be retrieved from the memory 212 of the electronic device 100 and presented alongside the one or more processors upcoming occasions 223 retrieved from the remote electronic device 240 across the network 241 as potential execution dates for an electronic payment transaction request 232.

In one or more embodiments, special occasion data store 202 also stores dates 219 associated with each of the upcoming occasions 223. This allows the one or more processors 206 to also present the one or more dates 219 corresponding to the one or more upcoming occasions 223 when an electronic payment transaction request 232 is requested. Said differently, in one or more embodiments the one or more processors 206 present one or more dates 219 corresponding to the one or more upcoming occasions on the user interface 109.

In one or more embodiments, these dates 219 comprise estimated dates when the one or more occasions comprise religious festivals. Embodiments of the disclosure contemplate that the start of a religious festival may be designated in view of weather, for example, so in some instances the dates 219 presented with the one or more upcoming occasions 223 comprise estimated dates.

In one or more embodiments, the electronic device 100 comprises a prompt generator 230 as well. Embodiments of the disclosure contemplate that it can be advantageous to alert a user 110 as to when electronic payment transactions are going to execute. Illustrating by example, in one or more embodiments the one or more processors 206 present, on the user interface 109 on a selected occasion, a reminder notification 220 generated by the prompt generator 230 indicating that the payment transaction will execute.

In one or more embodiments, this reminder notification 220 is presented by the one or more processors 206 on the user interface 109 before the payment transaction will execute. Illustrating by example, the reminder notification 220 can be presented a predefined number of days, examples of which include two days, five days, or ten days, prior to the at least one occasion.

In one or more embodiments, the electronic device 100 also includes a transaction manager 211. In one or more embodiments, the transaction manager 211 and the prompt generator 230 can be operable with one or more processors 206, configured as a component of the one or more processors 206, or configured as one or more executable code modules operating on the one or more processors 206. In other embodiments, the transaction manager 211 and the prompt generator 230 can be standalone hardware components operating executable code or firmware to perform their functions. Other configurations for the transaction manager 211 and the prompt generator 230 will be obvious to those of ordinary skill in the art having the benefit of this disclosure.

In one or more embodiments, the transaction manager 211 is operable to determine, from user input 231 received from the user interface 109, whether an electronic payment transaction request 232 is a singular electronic payment transaction request 204 or an annual electronic payment transaction request 205. When the electronic payment transaction request 232 is a singular electronic payment transaction request 204, the one or more processors 206 cause the electronic payment transaction associated with the electronic payment transaction request 232 to execute on the one or more occasions selected by the user 110. However, when the electronic payment transaction request 232 is an annual electronic payment transaction request 205, the one or more processors 206 cause the electronic payment transaction to execute on the one or more occasions selected by the user 110 every year.

In one or more embodiments, when the user interface 109 receives a selection of one or more upcoming occasions for payment, the transaction manager 211 can perform other operations as well. Illustrating by example, the transaction manager 211 can be configured to determine a date 219 corresponding to each occasion of the one or more occasions and can cause the electronic payment transaction to execute on that date. Thus, in one or more embodiments the transaction manager 211 can perform a translation function translating one or more selected upcoming occasions to defined dates to that the electronic payment transaction can occur on a specific date. This allows the electronic device 100 to more efficiently communicate with legacy systems that only “speak” in terms of actual dates.

It is to be understood that FIG. 2 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure.

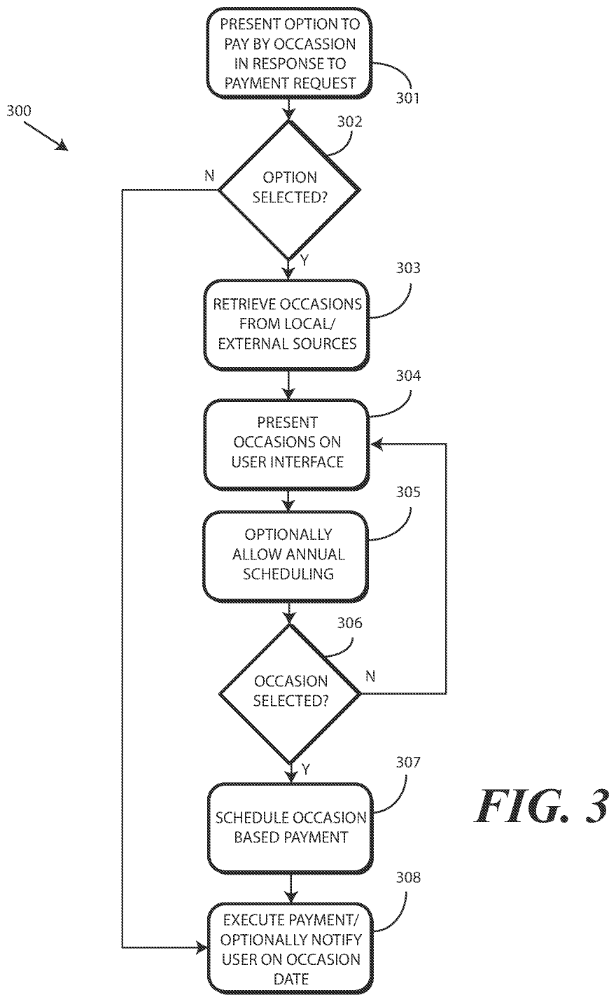

Turning now to FIG. 3, illustrated therein is one explanatory method 300 in accordance with one or more embodiments of the disclosure. Beginning at step 301, one or more processors of an electronic device present, on a user interface of the electronic device, a user actuation target facilitating payment of an electronic payment transaction by occasion. Decision 302 determines whether that user actuation target is selected or actuated.

Where it is, step 303 retrieves, using a communication device from a remote electronic device across a network, one or more upcoming occasions. Step 303 can also comprise retrieving one or more personal upcoming occasions from a local memory of the electronic device. In one or more embodiments, this retrieval occurring at step 303 occurs in response to actuation of an electronic payment transaction scheduling user actuation target presented in response to the electronic payment transaction request received at step 301.

Step 304 then comprises presenting, by the one or more processors on the user interface, the one or more upcoming occasions as potential execution dates for the electronic payment transaction that has been requested. In one or more embodiments, these upcoming occasions are presented in a list. In one or more embodiments, step 304 also comprises presenting a date associated with each upcoming occasion of the plurality of upcoming occasions. As noted above, in one or more embodiments this date can be an estimated date, such as when the upcoming occasion is a religious festival or when the scheduled date for the upcoming occasion changes every year. As will be explained below, step 307 can comprise determining the actual date thereafter so that the electronic payment transaction can be properly scheduled.

Optional step 305 can comprise presenting a periodic user actuation target as well. In one or more embodiments, when the periodic user actuation target is selected, the electronic payment transaction will be scheduled to execute annually. As noted earlier, in one or more embodiments, had the selected occasion been a monthly, semi-annual, quarterly, or other type of frequency, then the electronic payment transaction will be scheduled accordingly.

Decision 306 then determines whether an occasion is selected. Where it is, step 307 determines, by one or more processors from user input received by the user interface with the selection detected at decision 306, whether the electronic payment transaction request is a singular electronic payment transaction request or an annual electronic payment transaction request. Where the electronic payment transaction request is a singular electronic payment transaction request, step 307 comprises causing the electronic payment transaction to execute on the one or more occasions. By contrast, when the electronic payment transaction request is an annual electronic payment transaction request, step 307 comprises causing the electronic payment transaction to execute on the one or more occasions every year. Step 307 can further comprise determining, by the one or more processors, a date corresponding to each occasion of the one or more occasions and scheduling the electronic payment transaction to execute on the date as noted above.

Optional step 308 can comprise presenting, by the one or more processors on the user interface, a prompt prior to the electronic payment transaction occurring. In one or more embodiments, this prompt is presented within a predefined number of days prior to the one or more occasions indicating that the electronic payment transaction will occur.

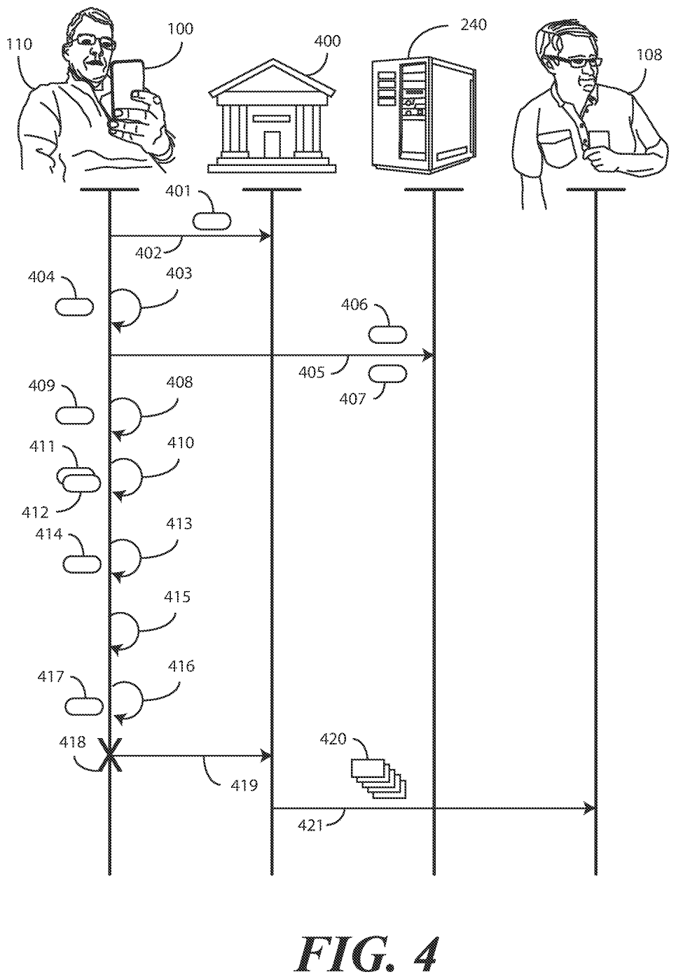

Turning now to FIG. 4, illustrated therein is one explanatory signal flow diagram in accordance with one or more embodiments of the disclosure. A user 110 delivers user input to a user interface of an electronic device 100 requesting 402 an electronic payment transaction 401 be executed by a financial institution 400. One or more processors of the electronic device 100 then present 403, on a user interface of the electronic device, a user actuation target 404 facilitating the electronic payment transaction 401 by occasion.

When thus user actuation target 404 facilitating the electronic payment transaction 401 by occasion is actuated, the one or more processors of the electronic device 100 retrieve 405, from a remote electronic device 240 across a network, one or more upcoming occasions 406. The one or more processors can also retrieve 408 one or more other upcoming occasions 409 from a memory of the electronic device 100. In one or more embodiments, the one or more processors of the electronic device 100 also retrieve 405 from the remote electronic device 240, one or more dates 407 corresponding to the one or more upcoming occasions 406.

Thereafter, the one or more processors present 410 the one or more upcoming occasions 406, and optionally the dates 407 for the one or more other upcoming occasions 409, on the user interface as execution dates 411 for the electronic payment transaction 401. In one or more embodiments, these one or more upcoming occasions 406, and optionally the one or more other upcoming occasions 409, are presented in a list. Optionally, the one or more processors can also present 410 a periodic execution user actuation target 412 that, when executed, results in the electronic payment transaction 401 being scheduled to execute on the at least one occasion selected periodically.

The one or more processors can then receive 413, at the user interface, a selection of at least one occasion 414 for the electronic payment transaction 401 to execute. The one or more processors can then schedule, in response to the selection, the electronic payment transaction 401 to execute on the at least one occasion.

In one or more embodiments, the one or more processors can optionally present 416, on the user interface prior to the at least one occasion, a notification 417 that the electronic payment transaction 401 will execute. In one or more embodiments, this presentation 416 of the notification 417 occurs a predefined number of days prior to the occasion. In other embodiments, the one or more processors can present 416 this notification 417 on the occasion.

When the occasion 418 arrives, the one or more processors can automatically execute 419 the electronic payment transaction 401 so that funds 420 are delivered 421 from the financial institution 400 to the recipient, which in this example is the charity representative 108.

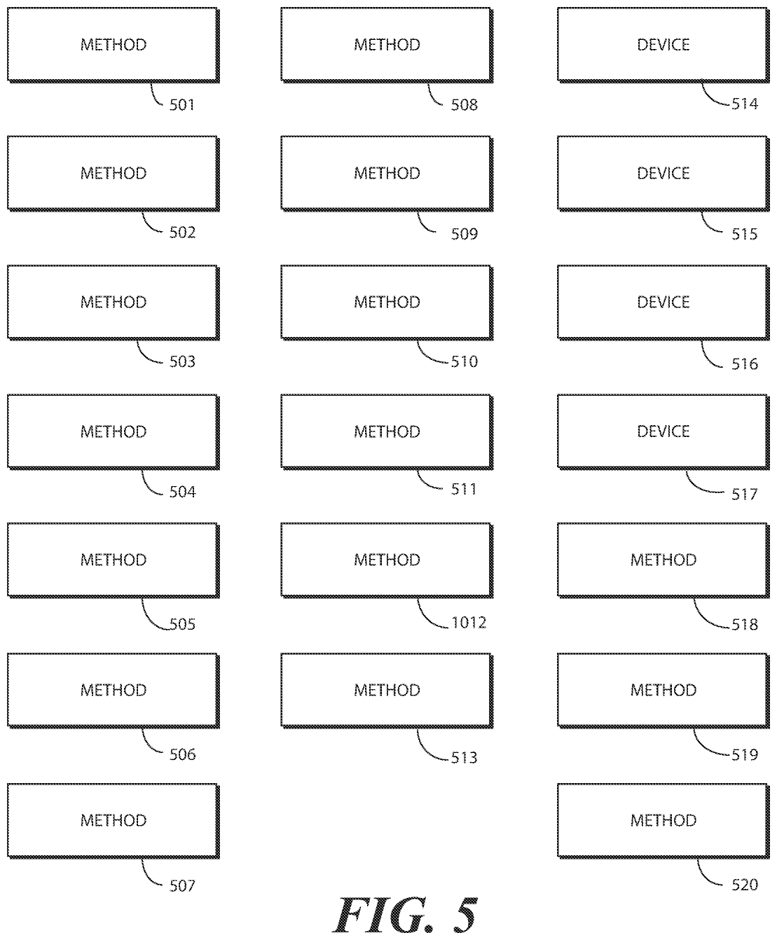

Turning now to FIG. 5, illustrated therein are various embodiments of the disclosure. The embodiments of FIG. 5 are shown as labeled boxes in FIG. 5 due to the fact that the individual components of these embodiments have been illustrated in detail in FIGS. 1-4, which precede FIG. 5. Accordingly, since these items have previously been illustrated and described, their repeated illustration is no longer essential for a proper understanding of these embodiments. Thus, the embodiments are shown as labeled boxes.

At 501, a method in an electronic device comprises receiving, at a user interface, user input requesting an electronic payment transaction. At 501, the method comprises presenting, by one or more processors on the user interface in response to the receiving, a user actuation target facilitating the electronic payment transaction by occasion.

At 501, the method comprises retrieving, with a communication device from a remote electronic device across a network, one or more upcoming occasions. At 501, the method comprises presenting, by the one or more processors on the user interface, the one or more upcoming occasions as execution dates for the electronic payment transaction.

At 502, the method of 501 further comprises receiving, at the user interface, a selection of at least one occasion. At 502, the method comprises scheduling, by the one or more processors in response to the selection, the electronic payment transaction to execute on the at least one occasion.

At 503, the method of 502 further comprises also presenting, by the one or more processors on the user interface, a periodic execution user actuation target. At 503, the scheduling comprises scheduling the electronic payment transaction to execute on the at least one occasion periodically when the periodic execution user actuation target is selected.

At 504, the method of 502 further comprises presenting, by the one or more processors on the user interface on the at least one occasion, a reminder notification that the electronic payment transaction will execute. At 505, the method of 502 further comprises presenting, by the one or more processors on the user interface prior to the at least one occasion, a notification that the electronic payment transaction will execute. At 506, the presenting of 505 occurs a predefined number of days prior to the at least one occasion.

At 507, the method of 501 further comprises retrieving, with the one or more processors from a memory of the electronic device, one or more other upcoming occasions stored in the memory. At 507, the presenting comprises also presenting at least some of the one or more other upcoming occasions with the one or more upcoming occasions as the execution dates for the electronic payment transaction. At 508, the at least some of the one or more other upcoming occasions and the one or more upcoming occasions of 508 are presented in a list.

At 509, the method of 508 further comprises also presenting, by the one or more processors on the user interface, an annual execution user actuation target. At 510, the annual execution user actuation target pf 509 is presented beneath the list.

At 511, the presenting of 501 further comprises presenting one or more dates corresponding to one or more upcoming occasions. At 512, the one or more dates of 511 correspond to the one or more upcoming occasions are estimated dates when the one or more occasions comprise religious faith festivals.

At 513, the method of 501 further comprises presenting, by the one or more processors on the user interface in response to the user input, an electronic payment transaction execution user actuation target and an electronic payment transaction scheduling user actuation target on the user interface. At 513, the retrieving the one or more upcoming occasions occurs only in response to actuation of the electronic payment transaction scheduling user actuation target.

At 514, an electronic device comprises a user interface, a communication device, and one or more processors operable with the user interface and the communication device. At 514, the one or more processors are operable to, in response to user input received by the user interface requesting execution of an electronic payment transaction, cause a schedule by occasion user actuation target to be presented on the user interface. At 514, the one or more processors are operable to, in response to actuation of the schedule by occasion user actuation target, present a plurality of upcoming occasions available for execution of the electronic payment transaction on the user interface.

At 515, the one or more processors of 514 also present a date associated with each upcoming occasion of the plurality of upcoming occasions. At 516, the date of 515 is estimated when a scheduled date for a corresponding upcoming occasion changes from year to year. At 517, the one or more processors of 514 cause the electronic payment transaction to be executed on an occasion selected from the plurality of upcoming occasions.

At 518, a method in an electronic device comprises presenting, by one or more processors on a user interface in response to an electronic payment transaction request, a plurality of occasions. At 518, the method comprises receiving, by the user interface, a selection of one or more occasions to execute an electronic payment transaction identified by the electronic payment transaction request. At 518, the method comprises determining, by the one or more processors from user input received by the user interface with the selection, whether the electronic payment transaction request is a singular electronic payment transaction request or an annual electronic payment transaction request.

At 518, when the electronic payment transaction request is a singular electronic payment transaction request, the method comprises causing the electronic payment transaction to execute on the one or more occasions. At 518, when the electronic payment transaction request is an annual electronic payment transaction request, the method comprises causing the electronic payment transaction to execute on the one or more occasions every year.

At 519, the method of 518 further comprises presenting, by the one or more processors on the user interface, a prompt prior to the electronic payment transaction occurring. At 519, the prompt is presented within a predefined number of days prior to the one or more occasions indicating that the electronic payment transaction will occur.

At 520, the method of 519 further comprises determining, by the one or more processors, a date corresponding to each occasion of the one or more occasions. At 520, the causing the electronic payment transaction to execute occurs on the date.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, at a user interface, user input requesting an electronic payment transaction;
presenting, by one or more processors on the user interface in response to the receiving, a user actuation target facilitating the electronic payment transaction by occasion;
retrieving, with a communication device from a remote electronic device across a network, one or more upcoming occasions; and
presenting, by the one or more processors on the user interface, the one or more upcoming occasions as execution dates for the electronic payment transaction.

2. The method of claim 1, further comprising:
receiving, at the user interface, a selection of at least one occasion; and
scheduling, by the one or more processors in response to the selection, the electronic payment transaction to execute on the at least one occasion.

3. The method of claim 2, further comprising also presenting, by the one or more processors on the user interface, a periodic execution user actuation target, wherein the scheduling comprises scheduling the electronic payment transaction to execute on the at least one occasion periodically when the periodic execution user actuation target is selected.

4. The method of claim 2, further comprising presenting, by the one or more processors on the user interface on the at least one occasion, a reminder notification that the electronic payment transaction will execute.

5. The method of claim 2, further comprising presenting, by the one or more processors on the user interface prior to the at least one occasion, a notification that the electronic payment transaction will execute.

6. The method of claim 5, wherein the presenting occurs a predefined number of days prior to the at least one occasion.

7. The method of claim 1, further comprising retrieving, with the one or more processors from a memory of the electronic device, one or more other upcoming occasions stored in the memory, wherein the presenting comprises also presenting at least some of the one or more other upcoming occasions with the one or more upcoming occasions as the execution dates for the electronic payment transaction.

8. The method of claim 7, wherein the at least some of the one or more other upcoming occasions and the one or more upcoming occasions are presented in a list.

9. The method of claim 8, further comprising also presenting, by the one or more processors on the user interface, an annual execution user actuation target.

10. The method of claim 9, wherein the annual execution user actuation target is presented beneath the list.

11. The method of claim 1, wherein the presenting further comprises presenting one or more dates corresponding to one or more upcoming occasions.

12. The method of claim 11, wherein the one or more dates corresponding to the one or more upcoming occasions are estimated dates when the one or more occasions comprise religious faith festivals.

13. The method of claim 1, further comprising presenting, by the one or more processors on the user interface in response to the user input, an electronic payment transaction execution user actuation target and an electronic payment transaction scheduling user actuation target on the user interface, wherein the retrieving the one or more upcoming occasions occurs only in response to actuation of the electronic payment transaction scheduling user actuation target.

14. An electronic device, comprising:
a user interface;
a communication device; and
one or more processors operable with the user interface and the communication device;
the one or more processors operable to, in response to user input received by the user interface requesting execution of an electronic payment transaction, cause a schedule by occasion user actuation target to be presented on the user interface and, in response to actuation of the schedule by occasion user actuation target, present a plurality of upcoming occasions available for execution of the electronic payment transaction on the user interface.

15. The electronic device of claim 14, wherein the one or more processors also present a date associated with each upcoming occasion of the plurality of upcoming occasions.

16. The electronic device of claim 15, wherein the date is estimated when a scheduled date for a corresponding upcoming occasion changes from year to year.

17. The electronic device of claim 14, wherein the one or more processors cause the electronic payment transaction to be executed on an occasion selected from the plurality of upcoming occasions.

18. A method in an electronic device, the method comprising:
presenting, by one or more processors on a user interface in response to an electronic payment transaction request, a plurality of occasions;
receiving, by the user interface, a selection of one or more occasions to execute an electronic payment transaction identified by the electronic payment transaction request;
determining, by the one or more processors from user input received by the user interface with the selection, whether the electronic payment transaction request is a singular electronic payment transaction request or an annual electronic payment transaction request; and
one of:
when the electronic payment transaction request is a singular electronic payment transaction request, causing the electronic payment transaction to execute on the one or more occasions; and
when the electronic payment transaction request is an annual electronic payment transaction request, causing the electronic payment transaction to execute on the one or more occasions every year.

19. The method of claim 18, further comprising presenting, by the one or more processors on the user interface, a prompt prior to the electronic payment transaction occurring and within a predefined number of days prior to the one or more occasions indicating that the electronic payment transaction will occur.

20. The method of claim 19, further comprising determining, by the one or more processors, a date corresponding to each occasion of the one or more occasions, wherein the causing the electronic payment transaction to execute occurs on the date.
